(19) United States
(12) Patent Application Publication
(10) Pub. No.: US 2006/0193319 A1
(43) Pub. Date: Aug. 31, 2006

(54) System and method for providing packet communication service

(76) Inventor: Jung--Sic Sung, Yongin-si (KR)

Correspondence Address: Robert E. Bushnell, Suite 300, 1522 K Street, N.W., Washington, DC, 20005-1202, US

(21) Appl. No.: 11/350,073

(22) Filed: Feb. 9, 2006

(30) Foreign Application Priority Data
Feb. 28, 2005 (KR) 10-2005-0016826

(51) Int. Cl. H04J 3/16; H04L 12/56; H04L 12/28; H04J 3/22

(52) U.S. Cl. 370/389; 370/401; 370/466

(57) ABSTRACT

In a system and method for providing a packet communication service in a network system, a plurality of private networks are connected to one another through a public network. When a voice call is established between Internet protocol (IP) terminals included in respectively different private networks, packets can be directly exchanged between the IP terminals using public address information and port information of the IP terminals so that packet transmission delay can be minimized and network resources can be used efficiently.

### CLAIM OF PRIORITY

his application makes reference to, incorporates the same herein, and claims all benefits accruing under 35 U.S.C. § 119 from an application for SYSTEM AND METHOD FOR PROVIDING PACKET COMMUNICATION SERVICE filed in the Korean Intellectual Property Office on Feb. 28, 2005 and there duly assigned Ser. No. 10-2005-0016826.

### BACKGROUND OF THE INVENTION

1. Technical Field

The present invention relates to a system and method for providing a packet communication service. More particularly, the present invention relates to a system and method for providing a packet communication service in a network system where a plurality of private networks are connected to one another through a public network, whereby when a voice call is established between IP terminals included in respectively different private networks, packets can be directly exchanged between the IP terminals.

2. Related Art

Today, with increasing widespread use of the Internet, there is increased interest in a Voice over Internet protocol (VoIP) service.

By embodying an integrated telephone service using an IP network, the VoIP service provides telephone users with long distance calling and international direct dialing service via the Internet or an Intranet environment at the same cost as local calling. In VoIP, protocols such as session Initiation protocol (SIP), media gateway control protocol (MGCP), and H.323 are defined.

The SIP is an application layer control protocol based on simple text, in which one or more participants can generate/correct/terminate a session with one another. The session can be any one of a teleconference, a telephone call, an event notification, an instant message, etc., using the Internet.

The MGCP, also known as “H.248” or “Megaco”, is a standard protocol for signal operation and session management needed during a multimedia conference.

The H.323 is a standard defined in “ITU-T” for transmitting video conference data through a network of a packet switching scheme such as TCP/IP.

Meanwhile, since new public Internet protocol (IP) addresses based on the IPv4 address system are running out as the number of Internet users continues to increase, a method of solving the shortage of public IP addresses by introducing a private IP address system using a technique such as network address translation (NAT) has been introduced.

NAT is proposed to solve the problem of shortage of public IP addresses by enabling a large number of Internet users to use a small number of public IP addresses in an IP network, as explained in a general agreement of “Request for Comments (RFC) 1631”.

IP networks, including general private networks, comprise a private network using a private IP address, a public network using a public IP address, a network address converter for converting a private IP address used in the private network into a corresponding public IP address, and a switching system.

If a user wishes to use the VoIP service through a private IP terminal in the IP network, a manager has to set up public IP addresses which are mapped 1:1 to private IP addresses of each IP terminal in a switching system so as to connect a voice call between private IP terminals.

Furthermore, the private IP terminal sets up a source IP address as a private IP address according to telephone number information inputted by the user, generates a call request message, the receiving IP address of which is set up as a public IP address of the switching system, and transmits the message to the IP network.

The network address converter converts the IP address set up as the source IP address of the call request message received from the private IP terminal into a corresponding public IP address and transmits it to the switching system.

The switching system recognizes the receiving IP address of the call request message received from the network address converter, and transmits the call request message to the receiving IP address.

When the receiving IP terminal responds to the call request message, voice calls between IP terminals included in different private networks are set up by way of the switching system, and a voice call service based on the VoIP is provided.

However, such a method for providing voice call service has a drawback in that the public IP address, corresponding to the private IP address of the IP terminal included in the private network, is available only when it is directly mapped to the network address converter.

Furthermore, packets exchanged between IP terminals pass through the switching system after the voice call between IP terminals included in different private networks is set up through the switching system. Thus, there is a problem of switching system resources being wasted.

Generally, the switching system includes a message control program (MCP) for controlling a voice call of each IP terminal, and a media gateway interface (MGI) for managing packets exchanged between IP terminals.

Accordingly, after a voice call between the IP terminals is set up through a message control program of the switching system, packets are exchanged through a media gateway interface. Such a media gateway interface is generally formed of a card having 16 ports. In the latter regard, since a task is performed where packets received from an IP terminal in the form of real-time transport protocol (RTP) data are converted into packets of pulse code modulation (PCM) data and then back into packets of RTP data, there is a packet transmission delay and sound quality deteriorates in the course of data conversion.

In addition, since the media gateway processor is a card having 16 ports, ports through which packets are exchanged between IP terminals are occupied when calls are set up between a plurality of IP terminals, resulting in waste of channel resources in the media gateway processor.

As technology for providing telephone service over the Internet develops, there is increasing interest in an Internet video telephone service through which video packets of video information are exchanged between IP terminals.

Accordingly, there is need for a method of directly exchanging voice packets of voice information and video packets of video information between IP terminals without passing through a switching system by setting up a voice call for voice communication between IP terminals included in different private networks.

### SUMMARY OF THE INVENTION

It is an objective of the present invention to provide a system and method for providing a packet communication service in a network system where a plurality of private networks are connected to one another through a public network, whereby when a call is established between Internet protocol (IP) terminals included in respectively different private networks, voice and video packets can be directly exchanged between the IP terminals

According to an aspect of the present invention, there is provided a system for providing a packet communication service including a switching server and at least one IP terminal connected to a public network through private networks which are different from one another, the system comprising: a switching server for transmitting a call request message received from a first IP terminal to a second IP terminal while managing address information or port information of each IP terminal; a second IP terminal for receiving the call request message from the switching server and for setting up first address information or first port information of the first IP terminal included in the call request message as destination information, transmitting a first message including second address information or second port information set up in advance to the first IP terminal, setting up destination information of a packet as the first address information or the first port information, and transmitting the destination information; and a first IP terminal for transmitting the call request message to the switching server through the first address information or the first port information, setting up the destination information of the packet as the second address information included in the first message or the second port information included in the first message, and transmitting the destination information.

The system of the present invention further includes at least one router for converting private address information or private port information included in the packet received from the private network into corresponding public address information or public port information, and for converting public address information or public port information included in the packet received from the public network into corresponding private address information or private port information.

Each router includes: a storage for storing an address conversion table having the private address information or private port information used in the private network by each IP terminal, and the public address information or public port information corresponding to the private address information or private port information; and an address conversion processor for searching for address information or port information corresponding to the address information or port information recognized in the test message or packet received from each IP terminal from the address conversion table, for converting the searched address information or port information, and for generating the address conversion table based on the address information or port information included in the first message.

The switching server includes: a database for storing telephone number information, address information, or port information of each IP terminal; and a terminal information manager for extracting the telephone number information, address information, or port information included in the test message received from each IP terminal and managing the information using the database, and for transmitting a call request message including address information or port information of the first IP terminal searched from the database to the second IP terminal when the call request message is received from the first IP terminal.

Each IP terminal of the system includes: a memory for storing address information assigned from the network or port information to exchange the packet; and a message processor for generating the test message using the address information or port information stored in the memory, and for transmitting the first message, in which the address information or port information of the first IP terminal recognized from the call request message received from the switching server is set up as destination information, to the first IP terminal when connected to the network.

The IP terminal further includes: a user interface for providing a telephone number signal or a voice signal based on a user's selection, and for outputting voice information based on the received voice signal; a video processor for providing a video signal based on video information to be photographed, and for displaying video information based on the received video signal, when a voice call is set up; and a controller for setting up the destination information of the packet based on the voice signal or video signal as address information or port information of a recognized opposite IP terminal and then transmitting the set information to the opposite IP terminal, and for transmitting the voice signal or video signal included in the packet received from the opposite IP terminal to the user interface or video processor.

According to another aspect of the present invention, an IP terminal connected to a network through a private network comprises: a memory for storing public address information assigned from the network, information on at least one public port exchanging packets, and public address information or information on at least one public port of another IP terminal recognized through a message received from the other IP terminal; a message generator for generating a plurality of test messages based on the public address information or each port information stored in the memory, a call request message based on a user's selection, and a response message for storing public address information or at least one port information recognized from an information transmission message received from the other IP terminal in the memory, and for setting up the recognized public address information or port information of the other IP terminal as destination information when connected to the network; and a packet processor for transmitting each message generated in the message generator to the network, for setting up the destination information of a voice packet generated based on a voice signal or a video packet generated based on a video signal as the recognized public address information or at least one public port information of the other IP terminal, and for transmitting the set information though the public port information stored in the memory.

According to yet another aspect of the present invention, there is provided a method for providing a service of a packet communication service provision system which includes at least one IP terminal connected to a public network through private networks that are different from one another and a switching server, the method comprising: managing, at the switching server, address information or port information of each IP terminal using an information table; when a call request message is received from a first IP terminal, transmitting, at the switching server, the call request message including address information or port information of the first IP terminal obtained from the information table to a second IP terminal; setting up, at the second IP terminal, the address information of the first IP terminal or the port information of the first IP terminal which is recognized from the call request message as destination information so as to transmit a first message in which the address information or port information set up in advance is set up as source information to the first IP terminal; and transmitting, at the first IP terminal, packets using the address information or port information of the second IP terminal recognized in the first message, and allowing the second IP terminal to transmit packets using the recognized address information or port information of the first IP terminal.

The method further includes: transmitting, at each IP terminal, a test message including assigned address information or port information to the switching server; and generating, at the switching server, an information table based on the address information or port information of each IP terminal included in the test message.

The method further includes: transmitting, at the switching server, an information request message including signaling port information in which the address information or signaling packet of the first IP terminal is exchanged with the second IP terminal; generating, at the second IP terminal, the first message in which the address information or signaling port information included in the information request message is set up as destination information; when address information or port information set up in each message or packet is private address information or private port information, converting the address information or port information into corresponding public address information or public port information and transmitting the converted information to the network; and, when the address information or port information set up in each message or packet is the public address information or the public port information, converting the address information or the port information into corresponding private address information or private port information, and transmitting the converted information to the IP terminal or the switching server through the corresponding private network.

The method further includes: transmitting, at the first IP terminal, a second message in which the address information of the second IP terminal or the port information of the second IP terminal, which is recognized in the received first message, is set up as destination information to the second IP terminal; allowing source information of a response message to be converted from the private address information of the first IP terminal or the private port information of the first IP terminal to public address information or public port information; and recognizing, at the second IP terminal, the public address information of the first IP terminal or the public port information of the first IP terminal included in the second IP message.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a block diagram showing the overall configuration of an Internet protocol (IP) network including a number of private networks;

FIG. 2 is a block diagram showing the internal configuration of an IP terminal in accordance with a preferred embodiment of the present invention;

FIG. 3 is a diagram showing the configuration of a packet;

FIG. 4 is a block diagram showing the internal construction of a router in accordance with a preferred embodiment of the present invention;

FIG. 5 illustrates an network address translation (NAT) table of a router in accordance with the present invention;

FIG. 6 is a block diagram showing the internal construction of a switching system in accordance with a preferred embodiment of the present invention;

FIG. 7 illustrates a terminal information table in accordance with a preferred embodiment of the present invention;

FIG. 8 is a flowchart of a method for providing video Internet telephone service in accordance with a preferred embodiment of the present invention;

FIGS. 9A to 9F are diagrams for explaining a link test message in accordance with an embodiment of the present invention;

FIG. 10 is a diagram for explaining an NAT table which a router generates according to a request message; and

FIG. 11 is a flowchart illustrating a method for providing Internet telephone service according to a preferred embodiment of the present invention.

### DETAILED DESCRIPTION OF THE INVENTION

A system and method for providing a packet communication service according to the present invention will now be described more fully with reference to the accompanying drawings.

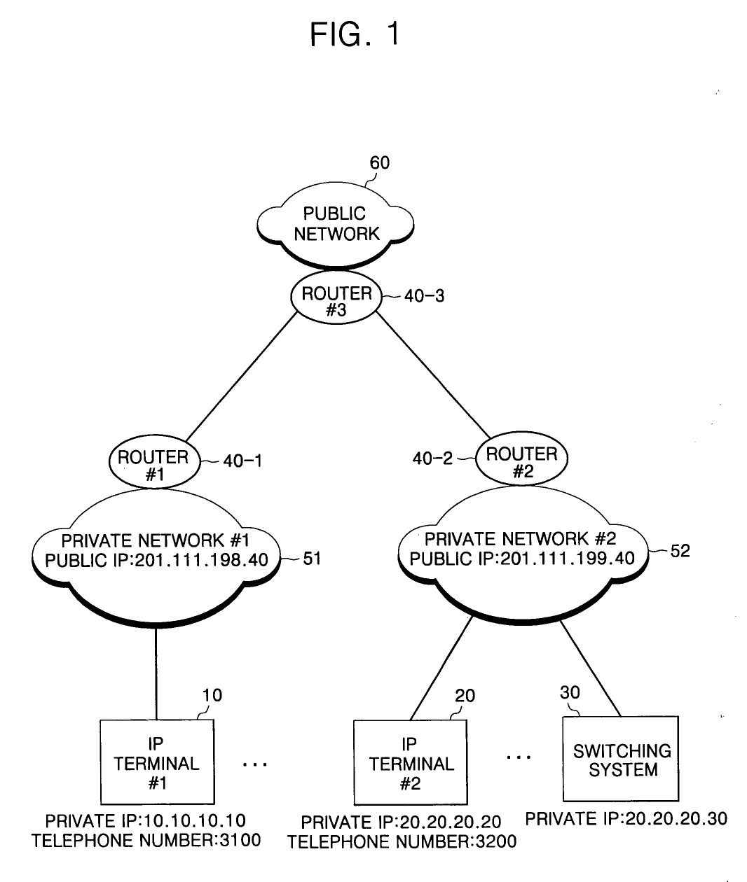

FIG. 1 is a block diagram showing the overall configuration of an Internet protocol (IP) network including a number of private networks.

Referring to FIG. 1, an IP network includes a number of IP terminals 10 and 20 connected to a number of private networks 51 and 52, a public network 60 connected to each of private networks 51 and 52 using assigned public IP addresses, a switching system 30 for setting up a voice call between the IP terminals 10 and 20 included in each of the private networks 51 and 52, and a number of routers 40-1, 40-2, and 40-3.

The public network 60 is a network to which each of terminals 10 and 20 is connected using a public IP address, and the public IP address used in the public network 60 is unique in the world and assigned and used by domestic and overseas IP address management institutes.

Hereinafter, although the present invention is described with reference to the case wherein a public IP address is a 32-bit IP address based on an IPv4 address system, the same principles also apply to the case wherein the public IP address is a 128-bit public IP address. based on an IPv6 address system.

Furthermore, in the private networks 51 and 52, the IP terminals 10 and 20 use private IP addresses intended for use in a unit or other organization only.

A number of routers 40-1, 40-2, and 40-3 route packets of voice information and video information received, and transmit corresponding packets to a destination.

Furthermore, each of the routers 40-1 and 40-2 connected to the private networks 51 and 52 converts source IP addresses transmitted from the IP terminals 10 and 20 into corresponding public IP addresses, and converts destination IP addresses of packets received from the public network 60 into corresponding private IP addresses.

That is, each of the routers 40-1 and 40-2 converts a private IP address included in a packet into a corresponding public IP address, and converts a public IP address into a corresponding private IP address, according to a network address translation function.

Furthermore, the routers 40-1 and 40-2 transmit received packets to the destination IP terminals 10 and 20 using the IP address information and port information of each of the IP terminals 10 and 20 while managing port information with which the IP terminals 10 and 20 exchange packets and IP address information relating to each of the IP terminals 10 and 20.

When receiving a call request message from the IP terminals 10 and 20, the switching system 30 recognizes the receiving IP terminals 10 and 20, and exchanges for setup a voice call between the calling IP terminals 10 and 20 and the receiving IP terminals 10 and 20 through an IP network. That is, the switching system 30 performs a switching server function so as to control a voice call of each of IP terminals 10 and 20.

Furthermore, when the switching system 30 receives a call request message while managing port information so as to exchange IP address information and packets of each of the IP terminals 10 and 20, it transmits an information request message after transmitting the port information of the calling IP terminal to the receiving IP terminal, so that the receiving IP terminal transmits port information to the calling IP terminal.

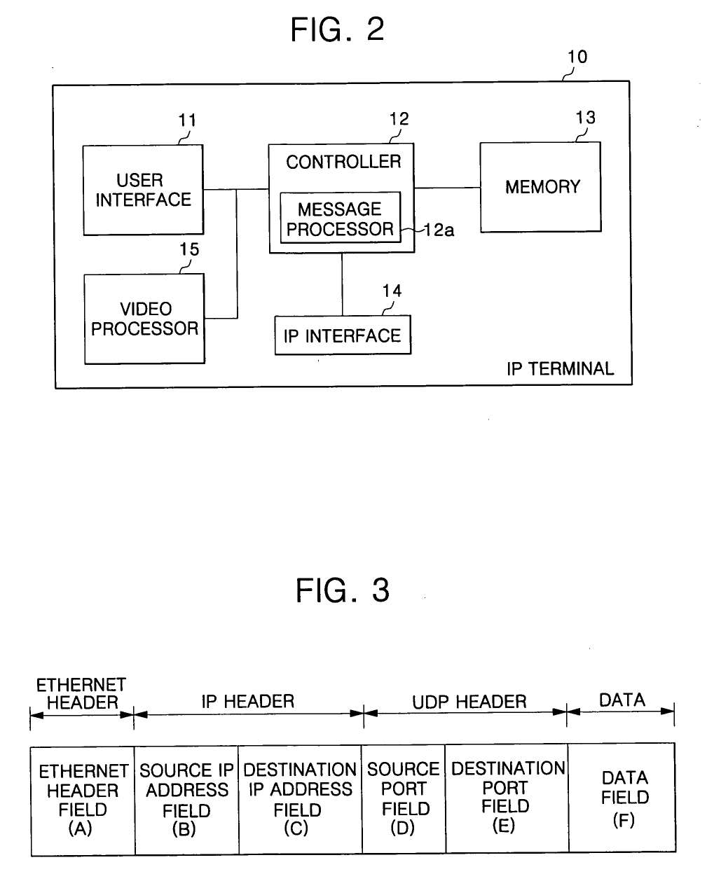

FIG. 2 is a block diagram showing the internal configuration of an IP terminal in accordance with a preferred embodiment of the present invention.

Referring to FIG. 2, the IP terminal 10 of the present invention includes a user interface 11, a controller 12, a memory 13, an IP interface 14, and a video processor 15, and the controller 12 includes a message processor 12a.

The user interface 11 provides an input signal based on telephone number information selected by the user, and provides the controller 12 with a voice signal containing voice information inputted by the user.

Furthermore, the user interface 11 outputs voice information based on the voice signal received from another IP terminal 20 wherein a voice call is set up in order that the user can listen to the voice information.

The video processor 15 can comprise a camera (not shown) for taking a video and a display (not shown) for displaying an image. It takes an image of an anterior view of the camera, and provides the controller 12 with a video signal when a voice call is set up in the IP terminal 10, and it displays video information based on the video signal received from the controller 12.

The memory 13 stores public or private IP address information assigned to the IP terminal 10, operation information of the IP terminal 10, and port information with which the packets are exchanged. At this point, the port information of the IP terminal can comprise signaling port information for exchange of a signaling packet used to set up the voice call, voice port information for exchange of the voice packet based on the voice signal, and video port information for exchange of the video packet based on the video signal.

The controller 12 generates a call request message according to an input signal provided by the user interface 11, and transmits it to the other IP terminal 20. Furthermore, when a voice call is connected to the other IP terminal 20, the controller 12 generates a voice packet based on the voice signal provided by the user interface 11, and a video packet based on the video signal provided by the video processor 15, and transmits them to the other IP terminal 20.

At this point, the controller 12 can compress and transmit the voice packet according to a standard such as “G.729” or “G.723”, and can compress the video packet according to a standard such as “H.216” or “H.263”.

Furthermore, the controller 12 transmits to the switching system 30 a response message responsive to a call request message received from other IP terminal 20, and sets up a voice call to the other IP terminal 10.

When the IP terminal 10 is connected to the switching system 30 through an IP network, the message processor 12a generates a test message, for example, a link test message (LinkTestMsg) with a predetermined period, and transmits it to the switching system 30.

At this point, information included in the link test message may be telephone number information of a corresponding IP terminal 10, IP address information, signaling port information, voice packet port information, video packet information, and port type information.

Furthermore, the message processor 12a periodically transmits to the switching system 30 a link test message including all of the signaling port information, the voice packet port information and video packet information, or periodically transmits to the switching system 30 each of a first link test message including the signaling port information, a second link test message including the voice packet port information, and a third link test message including the video packet port information.

The following description of the present invention concerns the case in which the IP terminal 10 periodically transmits to the switching system 30 each of the first link test message including the signaling port information, the second link test message including the voice packet port information and the third link test message including the video packet port information.

Meanwhile, when the message processor 12a receives an information request message after receiving the call connection request message from the switching system 30, it transmits a port request message to the other IP terminal 20 using the IP address information and port information of the other IP terminal 20 included in the call request message.

The message processor 12a generates a port response message in which the source IP address information and source port information included in the port request message received from the other IP terminal 20 are set up as the destination IP address information and destination port information, and then transmits them to the other IP terminal.

FIG. 3 is a diagram showing the configuration of a packet. As shown in FIG. 3, the packet can be generally divided into an Ethernet header area, an Internet protocol (IP) header area, a user datagram protocol (UDP) header area, and a data area.

The IP header area includes a source IP address field (B) and a destination IP address field (C), and the UDP header area comprises a source port field (D) and a destination port field (E).

The source IP address field (B) sets up 32-bit IP address information of the IP terminal 10 in order to transmit the packet, and the destination IP address field (C) sets up 32-bit IP address information of a final destination of the packet.

The source port field (D) has 16-bit port information used to transmit the packet in an application, and the destination port field (E) has 16-bit port information used to receive data in an application of the IP terminal that receives the packet.

The message processor 12a transmits a link test message, generated with a predetermined period, to the switching system 30 through adjacent routers 40-1 and 40-2.

That is, the message processor 12a sets up the private IP address information assigned to the IP terminal 10 from the private network 50 in the source IP address field (B) of the packet, the public IP address of the switching system 30 in the destination IP address field (C), the signaling port information in the source port field (D), the signaling port information of the switching system 30 in the destination port field (E), and port type information and telephone number information of the source port field (D) in the data field (F), and generates a first link test message with a predetermined period.

Furthermore, the message processor 12a sets up private IP address information assigned to the IP terminal 10 from the private network 50 in the source IP address field (B) of the packet, public IP address of the switching system 30 in the destination IP address field (C), packet port information in the source port field (D), voice packet port information of the switching system 30 in the destination port field (E), and port type information and telephone number information of the source port field (D) in the data field (F), and generates a second link test message with a predetermined period.

Furthermore, the message processor 12a sets up private IP address information assigned to the IP terminal 10 by the private network 50 in the source IP address field (B) of the packet, public IP address of the switching system 30 in the destination IP address field (C), packet port information in the source port field (D), video packet port information of the switching system 30 in the destination port field (E), and port type information and telephone number information of the source port field (D) in the data field (F), and generates a third link test message with a predetermined period.

The IP interface 14 performs an interfacing operation to transmit the first, second and third link test messages, generated by the message processor 12a, to the switching system 30 through the IP network. Furthermore, the IP interface 14 transmits the call request message generated by the controller 12 according to the input signal provided by the user interface 11 to the other IP terminal 10 through the switching system 30, or receives the call request message from the other IP terminal 10 through the switching system 30.

Furthermore, the IP interface 14 performs an interfacing operation to transmit the voice packet generated by the controller 12 according to the voice signal provided by the user interface 11 and the video packet generated by the controller 12 according to the video signal provided by the video processor 15 in such a state that a call is set up with the other IP terminal 10, or it transmits the voice packet and video packet received from the other IP terminal 10 through the IP network to the controller 12.

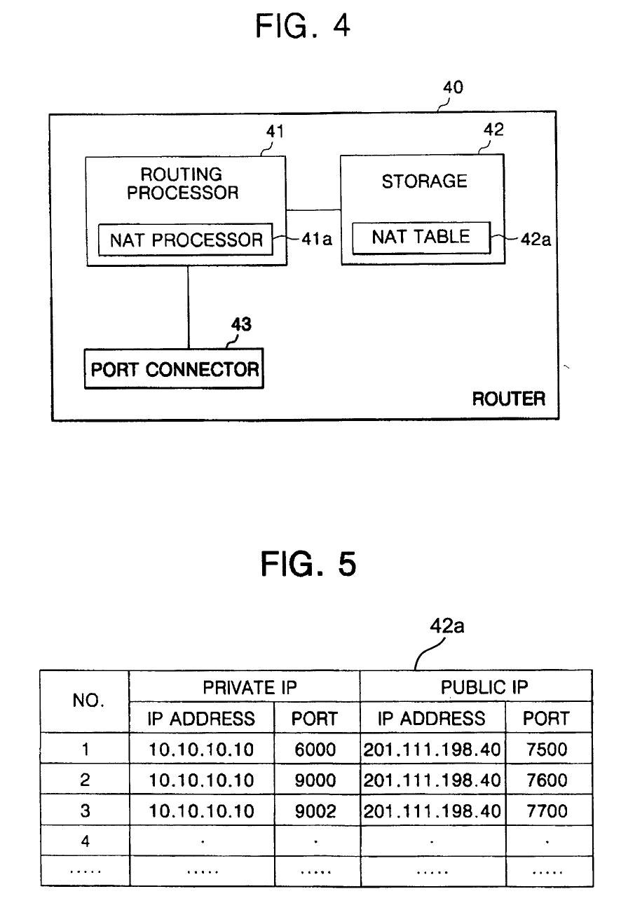

FIG. 4 is a block diagram showing the internal construction of a router in accordance with a preferred embodiment of the present invention.

Referring to FIG. 4, the router 40 of the present invention includes a routing processor 41, a storage 42, and a port connector 43.

The routing processor 41 includes a network address translation (NAT) processor 41a, and the storage 42 stores an NAT table 42a.

The port connector 43 provides the routing processor 41 with the packet received from the IP terminals 10 and 20 or the switching system 30 through the private networks 51 and 52 or the public network 60, and outputs the packet to a corresponding port according to a routing result determined by the routing processor 41.

The routing processor 41 searches a forwarding table (not shown) for a path through which to transmit the packet to the final destination set up in a header of the packet provided by the port connector 43, and transmits the packet along the path determined by the search.

That is, the routing processor 41 outputs the packet received according to port information by means of which each of IP terminals 10 and 20 exchanges the packet through a corresponding port.

The NAT processor 41a of the routing processor 41 searches the NAT table 42a for public IP address information corresponding to private IP address information included in the header of the packet received through the port connector 43, and then converts the IP address of the packet into the searched public IP address. Otherwise, the NAT processor 41a searches the NAT table 42a for private IP address information corresponding to public IP address information included in the header of the packet, and then converts the IP address of the packet into the searched IP address.

The NAT table 42a of the storage 42 stores private IP address information of each of the IP terminals 10 and 20 and port information used in the private networks 51 and 52, public IP address information of the private networks 51 and 52 including each of the IP terminals 10 and 20, and port information used in the public network 60.

FIG. 5 illustrates an NAT table of a router in accordance with the present invention.

Referring to FIG. 5, the NAT table 42a stores one private IP address information, signaling port information, voice packet port information and video packet information used in the corresponding private networks 51 and 52, public IP address information corresponding to private IP address information, and signaling port information, voice packet port information and video packet port information used in the public network 60.

As an example, in the case where the private IP terminal 10 having a private IP address of “10.10.10.10” has a signaling port of “6000”, a voice packet port of “9000”, and a video packet port of “9002”, the IP terminal 10 exchanges the packet to set up a voice call through a port number “6000”, the voice packet according to a voice signal through a port number “9000”, and a video packet according to a video signal through a port number “9002”.

The port connector 43 provides the routing processor 41 with the packet received from the IP terminal 10, and the NAT processor 41 a searches the NAT table 42a for public IP address information and port information corresponding to the private IP address information and port information set up in the source IP address field (B) and source port field (D) of the packet received, and then converts them into public IP address information and port information.

That is, the NAT processor 41a converts the private IP address information into the public IP address information according to the network address conversion function, and converts port information used in the private network 51 into port information used in the public network 60, and transmits them to the public network 60.

Meanwhile, the NAT processor 41a searches for private IP address information and port information corresponding to the public IP address information and port information set up in the source IP address field (B) and source port field (D) of the packet received through the public network 60, converts them into the private IP address information and port information, and transmits the converted information to the IP terminal 10 connected to the private network 51.

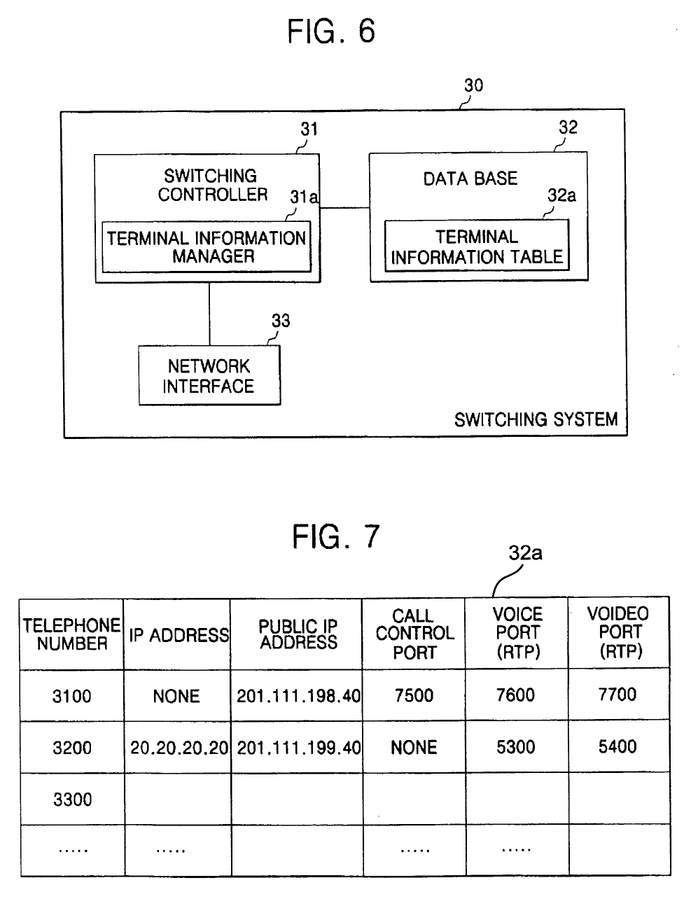

FIG. 6 is a block diagram showing the internal configuration of a switching system in accordance with a preferred embodiment of the present invention.

Referring to FIG. 6, the switching system of the present invention includes a switching controller 31, a database (DB) 32, and a network interface 33. Furthermore, the switching controller 31 includes a terminal information manager 31a, and the database 32 stores a terminal information table 32a.

The network interface 33 provides the switching controller 31 with a packet received through the IP network, that is, each link test message, a call request massage, and a response message.

Furthermore, the network interface 33 performs a switching operation to set up a voice call between the IP terminals 10 and 20 according to the received call request message and response message of the switching controller 31. That is, the switching controller 31 performs a switching operation to transmit the call request message received through the network interface 33 to the receiving IP terminal, transmits a response message relating to a call request message received from the receiving IP terminal to a calling IP terminal, and sets up a voice call.

The terminal information manager 31a of the switching controller 31 stores and manages telephone number information, private IP address information, public IP address information, and port information for each of the IP terminals 10 and 20 in the terminal information table 32a.

That is, the terminal information manager 31a manages telephone number information, private IP address information, public IP address information, and port information included in each link test message received through the network interface 33 using the terminal information table 32a.

Such a switching system 30 can recognize the IP address information and port information set up in a field of each received link test message through a parameter of a “recvform()” command.

FIG. 7 illustrates a terminal information table in accordance with a preferred embodiment of the present invention.

The terminal information table 32a shown in FIG. 7 corresponds to a case wherein the switching system 30 is included in the private network 52 as is the second IP terminal 20. The terminal information table 32a stores telephone number information, private IP address information, public IP address information, signaling port information, packet port information, and video packet port information for each of the IP terminals 10 and 20.

That is, the terminal information manager 31a recognizes the private IP address information and public IP address information from the source IP address field (B) of the first link test message received from each of the IP terminals 10 and 20, the signaling port information from the source port field (D), and the telephone number information and the port type information set up in the source port field (D) from the data field (F), and stores them in the terminal information table 32a.

Furthermore, the terminal information manager 31a recognizes the private IP address information and public IP address information from the source IP address field (B), the voice packet port information from the source port field (D), the telephone information from the data field (F), and the port type information set up in the source port field (D) in the second link test message received through the network interface 33, and stores them in the terminal information table 32a.

At the same time, the terminal information manager 31a recognizes the private IP address information and public IP address information from the source IP address field (B), the video packet port information from the source port field (D), the telephone number information from the data field (F), and the port type information set up in the source port field (D) in the third link test message received through the network interface 33, and stores them in the terminal information table 32a.

In this case, since the first, second and third link test messages transmitted by one of the IP terminals 10 and 20 have the same telephone number information and IP address information, it is desirable that, for one of the IP terminals 10 and 20, telephone number information or the IP address information is stored, and signaling port information, voice packet port information and video packet port information of the corresponding IP terminal 10 or 20 are stored, so that usage efficiency of the database 32, which is a storage area of the switching system 30, is maximized.

Meanwhile, since the switching system 30 is included in the same private network 52 as the second IP terminal 20, it is not possible to recognize signaling port information, even though it is possible to recognize the private IP address information through each link test message received from the second IP terminal 20. Furthermore, since the source IP address information of each link test message received from the first IP terminal 10 is converted into the public IP address information in the first router 40-1, it is not possible to recognize private IP address information. That is, the IP address information recognized through each link test message received from the first IP terminal 10 is public IP address information converted in the first router 40-1, and each port information is port information used in the public network 60.

Furthermore, each port information recognized by the switching system 30 through each link test message received from the second IP terminal 20, which is connected to the same second private network 52, is each port information used in the second private network 52.

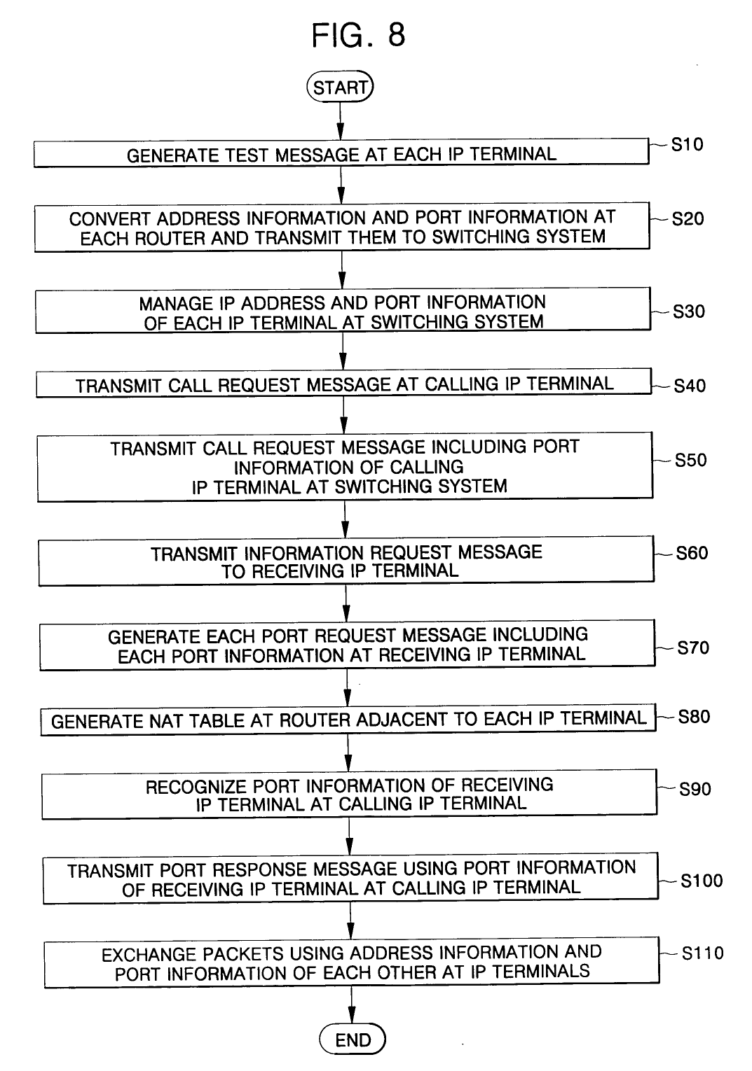

FIG. 8 is a flowchart of a method for providing video Internet telephone service in accordance with a preferred embodiment of the present invention.

Referring to FIG. 8, when each IP terminal 10 is connected to the IP network, each IP terminal 10 transmits a corresponding link test message, including port information and port type information, to the switching system 30 through each router 40-1 and 40-2 interlocked with the IP terminal 10 (S10).

At this point, each of the IP terminals 10 and 20 can periodically transmit the first, second and third link test messages, including signaling port information, voice packet port information and video packet port information, to the switching system 30.

Each of the router 40-1 and 40-2 converts private IP address information, and port information of each of the private networks 51 and 52 set up in the source IP address field B and source port field D of each link test message received from each of the IP terminals 10 and 20, into corresponding public IP address information of the public network 60 and port information used in the public network 60, and then transmits the converted information to the switching system 30 (S20).

For example, as shown in FIG. 1, a case will be explained wherein the second IP terminal 20 is connected to the same second private network 52 as the switching system 30.

The first IP terminal 10 generates the first, second and third link test messages, including the signaling port information, voice packet port information and video packet port information, and transmits the messages to the first router 40-1.

As shown in FIG. 1, in the case wherein the private IP address of the first IP terminal 10 is “10.10.10.10”, the signaling port information is “6000”, the voice packet port information is “9000”, and the video packet port information is “9002”, the first router 40-1 stores an NAT table 42a as shown in FIG. 5.

When the first IP terminal 10 is connected to the IP network, it periodically transmits each link test message to the switching system 30 through the first router 40-1.

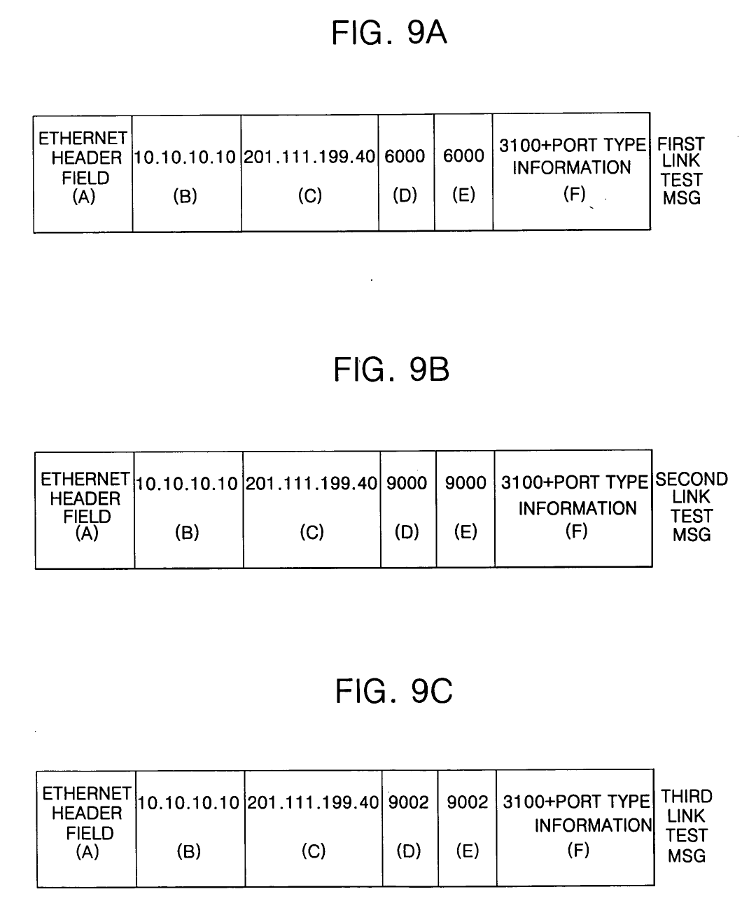

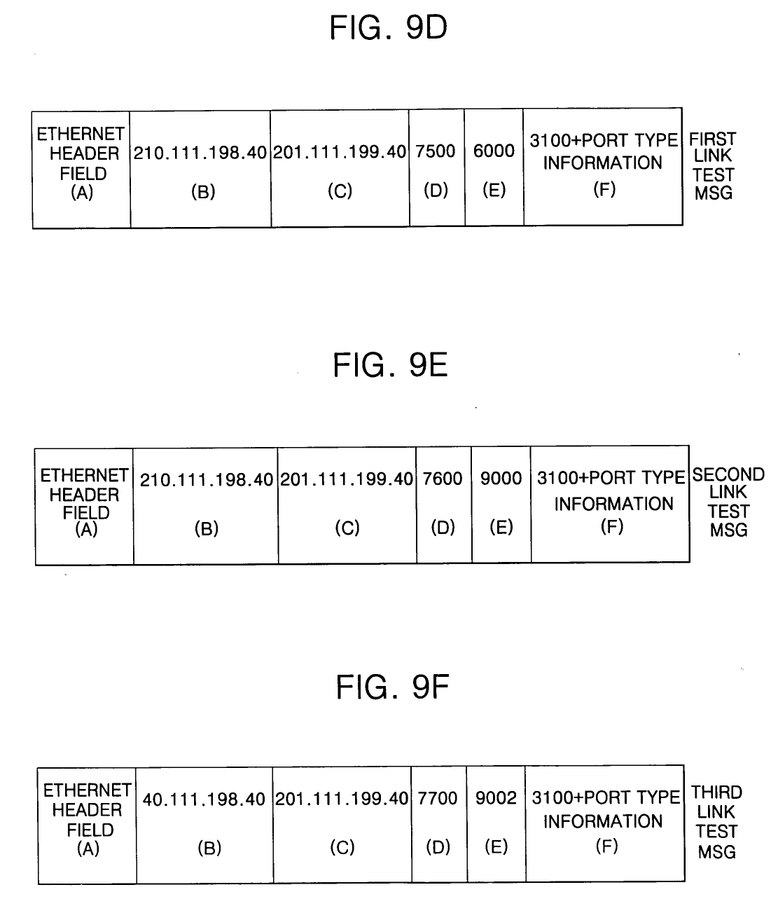

FIGS. 9A to 9F are diagrams for explaining a link test message in accordance with an embodiment of the present invention.

FIGS. 9A to 9C show each link test message generated by the first IP terminal 10, wherein the message processor 12a of the first IP terminal 10 periodically transmits to the first router 40-1 a first link test message having a header field (A), a source IP address field (B) set with a private IP address of “10.10.10.10”, a destination IP address field (C) set with the public IP address of the second private network 52 of “201.111.199.40” including the switching system 30, a source port field (D) set with signaling port information of “6000”, a destination port field (E) set with signaling port information of the switching system 30, and a data field (F) set with telephone number information of “3100” and port type information set in the source port field (D), as shown in FIG. 9A.

Furthermore, the message processor 12a of the first IP terminal 10 periodically transmits to the first router 40-1 a second link test message having a header field (A), a source IP address field (B) set with a public IP address of “10.10.10.10”, a destination IP address field (C) set with the public IP address of the second private network of “201.111.199.40” including the switching system 30, a source port field (D) set with the voice packet port information of the first IP terminal 10 of “9000”, a destination port field (E) set with destination port information, and the data field (F) set with telephone number information of “3100” and the port type information set up in the source port field (D), as shown in FIG. 9B.

Simultaneously, the message processor 12a of the first IP terminal 10 periodically transmits to the first router 40 a third link test message having a header field (A), a source IP address field (B) set with a private IP address of “10.10.10.10”, a destination IP address field (C) set with the public IP address of the second private network 52 of “201.111.199.40” including the switching system 30, a source port field (D) set with a signaling port information of the first IP terminal 10 of “9002”, a destination port field (E) set with destination port information and a data field (F) set with telephone number information of “3100 and port type information set up in the source port field (D), as shown in FIG. 9C.

The NAT processor 41a of the first router 40 recognizes private IP address information and port information of the first IP terminal 10 from the source IP field (B), source port field (D) and data field (F) of the first, second and third link test messages which are received through the port connector 43.

Furthermore, the NAT processor 41a searches for private IP address information recognized in the NAT table 42a, public IP address information corresponding to port information, and the port information, converts information set up in the source IP address field (B) and source port field (D) into the public IP address information and port information searched for in the NAT table 42a, and transmits the converted information to the switching system 30.

That is, the first router 40-1 converts the IP address information set up in the source IP address information field (B) into the public IP address information of “210.111.198.40” corresponding to the private IP address information of “10.10.10.10”, and the port information set up in the source port field (D) into the signaling information of “7500” used in the public network 60 corresponding to the signaling port information of “6000” used in the first private network 51, and then transmits the first link test message received from the first terminal 10 to the switching network 30, as shown in FIG. 9D.

Furthermore, the first router 40-1 converts the IP public address information set up in the source IP field (D) of the second link test message and the third link test message into the public IP address information of “201.111.198.40”, the port information of the source port field (D) of the second link test message into the voice packet port information of “7600” used in the public network 60, and the port information of the source port field (D) of the third link test message into the video packet port information of “7700” used in the public network 60, and transmits the converted information to the switching system 30, as shown in FIGS. 9E and 9F.

At this point, the NAT processor 41a of the first router 40-1 can determine whether the port information set up in the source port field (D) of each link test message is the signaling port information, the voice packet port information or the video port information by recognizing the port type information stored in the data field (F) of each link test message received.

The switching system 30 recognizes the IP address information and port information included in the source IP address field (B), source port field (D) and data field (F) of each link test message received through the public network 60, and then stores each port information and IP address information of the first IP terminal 10 in the terminal information table 32a shown in FIG. 7.

That is, the terminal information manager 31 recognizes the telephone number information and port type information of the first IP terminal 10 from the data field (F) of each link test message received from the first router 40, public IP address information set up in the source IP address field (B), and each port information set up in the source port field (D), and then manages them in the terminal information table 32a.

Meanwhile, the second IP terminal 20 included in the same second private network 52 as the switching system 30 periodically transmits each link test message, including the signaling port information, voice packet port information, and video packet port information, to the switching system 30.

That is, the second IP terminal 20 sets up the private IP address information in the source IP address field (B), and transmits each link test message to the switching system 30, where each port information used in the second private network 52 is set up in the source port field (D).

Furthermore, the switching message 30 recognizes the telephone number information, private IP address information, public IP address information and port information included in each link test message received from the second IP terminal 20, and manages them in the same terminal information table 32a shown in FIG. 7 (see S30 of FIG. 8).

While the following description concerns the case where the first IP terminal 10 is a sender IP terminal and the second IP terminal 20 is a receiver IP terminal, the same principles of the present invention apply to other cases as well.

The first IP terminal 10 transmits a call request message to set up a voice call to the second IP terminal 20 according to a user selection (S40).

The controller 12 of the first IP terminal 10 transmits, to the switching system 30, the call request signal including telephone number information of the second IP terminal 20 of “3200” according to the input signal provided from the user interface 11.

At this point, the source IP address information of the call request message transmitted by the first IP terminal 10 can be converted from the private IP address information into the public IP address information in the first router 40-1, and the destination IP address information can be converted into the public IP address information of the switching system 30.

The switching system 30 includes, in the call request message, each port information of the first IP terminal 10, which is a calling IP terminal, and transmits it to the second IP terminal 20 of the receiving IP terminal based on the receiving telephone number information of the received call request message (S50).

At this point, the switching system 30 can transmit, to the second IP terminal 20, the signaling packet port information, the signaling packet of which is exchanged by the first IP terminal 10, voice packet port information having a voice packet which according to the voice signal is exchanged, and video packet port information having a video packet which according to the video signal is exchanged. That is, the switching system 30 includes the “7600” of the voice packet port information and the “7700” of the video packet port information of the first IP terminal 10 in the data field (F) of the call request message, and then transmits them to the second IP terminal 20.

Accordingly, when the second IP terminal 20 sets up a voice call to the first IP terminal 10 connected to the first private network 51 of the other private network, it can set up the destination port information of the voice packet based on the voice signal as the voice packet port information of the first IP terminal 10, and it can set up the destination port information of the video packet based on the video signal as the video packet port information of the first IP terminal 10, and it can then directly transmit the set information to the first IP terminal 10.

Meanwhile, the switching system 30 transmits an information request message, used to inform the first IP terminal 10 of the voice packet port information and video packet port information of the second IP terminal 30, to the second IP terminal 20 (S60).

At this point, the information request message transmitted to the second IP terminal 20 by the switching system 30 can include the signaling port information and public IP address information of the first IP terminal 10. That is, the second IP terminal 20 generates a port request message in response to the receiving information request message, and transmits to the second IP terminal 20 the public IP address information and signaling port information of the first IP terminal 10, so as to transmit the generated information to the first IP terminal 10.

When the second IP terminal 20 receives the information request message, it generates the voice port request message wherein the private IP address information is set up in the source IP address field (B), the public IP address information of the first IP terminal 10 is set up in the destination IP address field (C), and the voice packet port information is set up in the source port field (D), and transmits the messages to the first IP terminal 10 through the second router 40-2 (S70).

By way of example, the second IP terminal 20 sets up “20.20.20.20” of the private IP address information in the source IP address field (B), “9000” of the voice packet port information in the source port field (D), “201.111.199.40” of the public IP address of the first IP terminal 10 in the destination IP address field (C), and “7500” of the signaling port information of the first IP terminal 10 in the destination port field (E), and generates the voice port request message.

Furthermore, the second router 40-2 converts the source IP address information of the voice port request message generated in the second IP terminal 20 from the private IP address information to “201.111.199.40” of the public IP address information, converts the source port information into “5300”, and transmits them to the first IP terminal 10.

Accordingly, the first IP terminal 10 extracts and recognizes the source IP address information and source port information of the voice port request message received from the second IP terminal 20, uses them as the destination IP address information and destination port information of the voice packet to be transmitted to the second IP terminal 20, and then directly transmits the voice packet to the second IP terminal 20 without passing through the switching system 30.

In the same manner, the second IP terminal 20 generates the video port request message by setting up the video packet port information in the source port field (D), transmits the message to the first IP terminal 10, and then enables the first IP terminal 10 to transmit the video packet to the second IP terminal 20 directly.

The second router 40-2 recognizes the voice packet port information and video packet port information included in the voice port request message and video port request message received from the second IP terminal 20, and generates the NAT table 42a in which the private IP address information, public IP address information and each port information of the second IP terminal 20 are stored (S80).

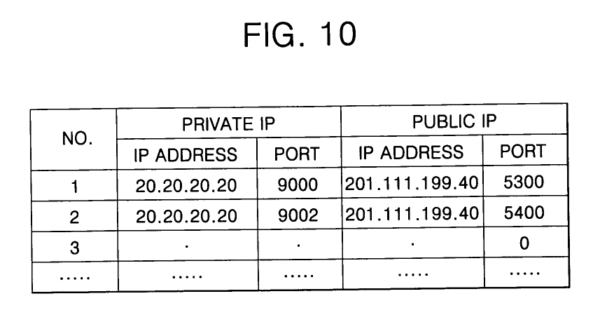

FIG. 10 is a diagram for explaining an NAT table which a router generates according to a request message.

Referring to FIG. 10, the second router 40-2 generates an NAT table 42a in which the public IP address information, and each packet of the second IP terminal 20 included in the voice port request message and video port request message received from the second IP terminal 20 of the receiving IP terminal, are stored.

Furthermore, the second router 40-2 converts the voice port request message and video port request message received from the second IP terminal 20 from the private IP address information of the source IP address field (B) into the public IP address information, converts the voice packet port information and video packet port information into the port information used in the public network 60, and then transmits the converted information to the first IP terminal 10 connected to the first private network 51 through the first router 40-1.

The first router 10 converts the destination IP address information of the voice port request message and video port request message into the private IP address information of the first IP terminal 10, and then transmits the converted information to the first IP terminal 10.

The first IP terminal 10 extracts and recognizes the private IP address information, voice packet port information and video packet port information included in the received voice port request message and video port request message, and generates a voice port response message and a video port response message using the extracted private IP address information, voice packet port information and video packet port information (S90).

Furthermore, the first IP terminal 10 transmits the voice port response message and video port response message to the second IP terminal 20 through the first router 41.

At this point, the first router 40-1 converts the source IP address message of each port response message received from the first IP terminal 10 from the private IP address information into the public IP address information, and the source port information from the port information used in the first private network 51 into the port information used in the public network 60, and then transmits the converted information to the second IP terminal 20 through the second router 40-2.

The second router 40-2 converts the source IP address information of each received port response message from the public IP address information into the private IP address information of the second private network 52, converts the source port information into the port information used in the second private network 52, and then transmits the converted information to the second IP terminal 20 (S100).

Furthermore, each of the IP terminals 10 and 20 transmits the voice packet and video packet to the other IP terminal using the recognized voice packet port information and video packet port information of the other IP terminal (S110).

That is, when the second IP terminal 20 responds to the call request message, the switching system 30 sets up a voice call between the first IP terminal 10 and the second IP terminal 20. When the voice call is set up, each of the IP terminals 10 and 20 can transmit the voice packet based on the voice signal using the public IP address information and voice packet port information of the other IP terminal, and the video packet based on the video signal directly using the public IP address information and the video packet port information of the other IP terminal.

For example, the first IP terminal 10 sets up the public IP address information of the second IP terminal 20 in the destination IP address field (C) while generating the voice packet based on the voice signal, sets up and generates the voice packet port information which the second IP terminal 20 uses in the public network 60 in the destination port field (E), and then transmits them to the first router 40-1.

The first router 40-1 recognizes the destination IP address information of the packet, and transmits the voice packet to the second router 40-2. The second router 40-2 converts the public IP address information of the destination IP address field (C) of the received voice packet into corresponding private IP address information, and converts the voice packet port information of the destination port field (E) into the voice packet port information used in the second private network 52, and then directly transmits them to the second IP terminal 20.

In the same manner, when the first and second IP terminals 10 and 20, the voice calls of which were set up in the public IP address information of the opposite IP terminal in the destination IP address field (E) of the voice packet and video packet and the port information of the opposite IP terminal in the destination port field (E), and transmits them, each of the routers 40-1 and 40-2 converts the public IP address information into private IP address information corresponding to the public IP address information set up in the received packet, and converts the port information into the port information used in the private networks 51 and 52, and then directly transmits them to each of IP terminals 10 and 20 connected to the private networks 51 and 52.

Furthermore, each of the routers 40-1 and 40-2 converts the public IP address information or private IP address information set up in the source IP address field (B) of the received packet into corresponding public IP address information or private IP address information, and port information set up in the source port field (D) into corresponding port information, and then transmits them to the receiving IP terminal.

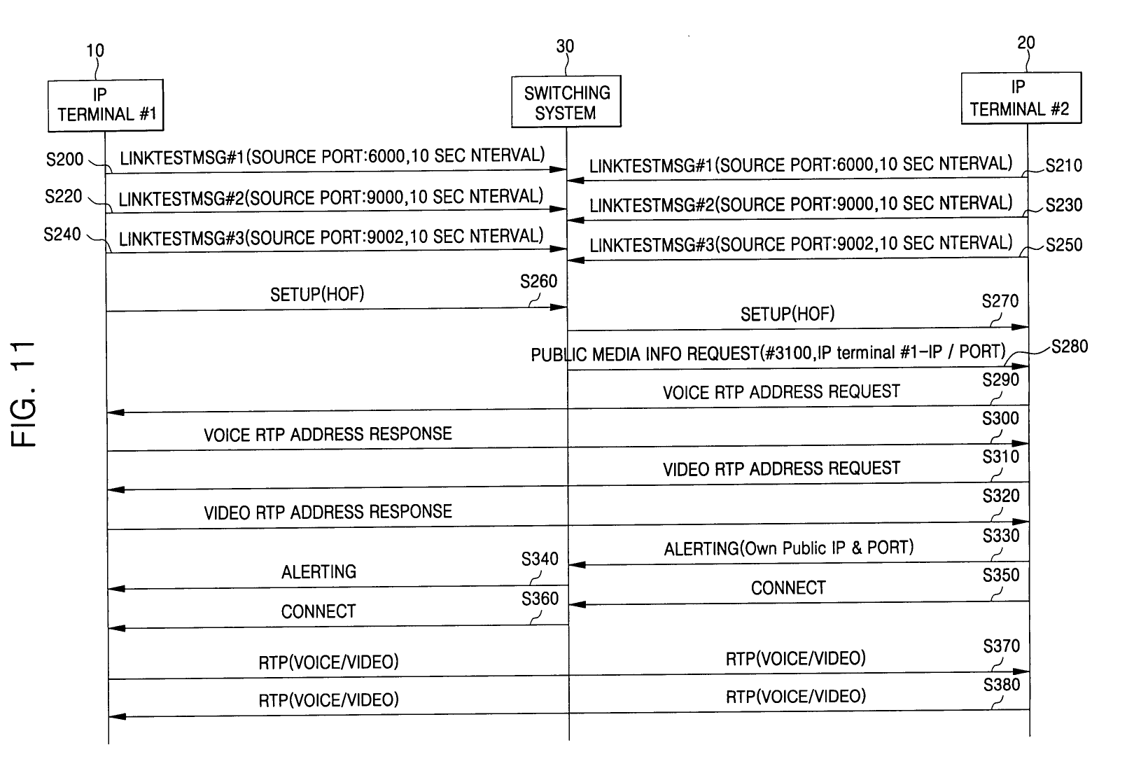

FIG. 11 is a flowchart illustrating a method for providing Internet telephone service according to a preferred embodiment of the present invention.

Referring to FIG. 11, when each of the IP terminals 10 and 20 is connected to the IP network, it transmits to the switching system 30 a first link test message (LinkTestMsg #1) including signaling port information to set up a voice call, a second link test message (LinkTestMsg #2) including voice packet port information to exchange the voice packet, and a third link test message (LinkTestMsg #3) including video packet port information to exchange the video packet with a predetermined period (S200, S210, S220, S230, S240 and S250).

At this point, each of the routers 40-1 and 40-2 connected to each of the private networks 51 and 52 converts private IP address information and port information of the private networks 51 and 52 set up in the source IP address field (B) and source port field (D) of each link test message (LinkTestMsg) received from each of the IP terminals 10 and 20 into corresponding public IP address information and port information of the public network 60, and transmits them to the switching system 30.

The switching system 30 recognizes telephone number information, private IP address information, public IP address information and the port information included in each link test message received from the second IP terminal 20, and manages them as such terminal information table 32a as shown in FIG. 7.

Meanwhile, if a user wishes to use an Internet telephone service to call the second IP terminal 20 using the first IP terminal 10, the second IP terminal 20 generates a call request message (Setup) in which telephone number information of the second IP terminal 20 is set up as receiving telephone number information according to the user selection, and transmits the message to the switching system 30 (S260).

When the switching system 30 receives the call request message, it transmits the call request message to the second IP terminal 20, the call request message including each port information of calling IP terminal 10 which is searched for in the terminal information table 32a (S270).

At this point, the switching system 30 can transmit to the second IP terminal 20 signaling packet port information having a signal packet which is exchanged by the first IP terminal 10, voice packet port information having a voice packet based on the voice signal which is exchanged, and video packet port information having a video packet based on the video signal which is exchanged.

Accordingly, the second IP terminal 20 can recognize each port information having a packet which is exchanged by the first IP terminal 10 connected to another private network 51.

Meanwhile, the switching system transmits the call request message to the second IP terminal 20, and transmits an information request message (Public Media Info Request), used to inform the first IP terminal 10 of voice packet port information and video packet port information of the second IP terminal 20, to the second IP terminal 20 of the receiving IP terminal (S280).

At this point, signaling port information and public IP address information of the first IP terminal 10, searched for in the terminal information table 32a, are included in the information request message of the switching system 30, and then transmitted.

When the second IP terminal 20 receives the information request message, it generates a voice port request message (Voice RTP Address request) having a private IP address information which is set up in the source IP address field (B), public IP address information of the first IP terminal 10 which is set up in the destination IP address field (C), and voice packet port information which is set up in the source port field (D), and transmits it to the first IP terminal 10 (S290).

The first IP terminal 10 recognizes private IP address information and voice packet port information of the second IP terminal 20 included in the received voice port request message, and then transmits to the second IP terminal 20 the voice port response message (Voice RTP Address response) in which the private IP address information and voice packet port information of the second IP terminal 20 are set up as destination IP address information and destination port information (S300).

Furthermore, when the second IP terminal 20 receives an information request message, it generates a video port request message (Video RTP Address request) having a private IP address information which is set up in the source IP address field (B), public IP address information of the first IP terminal 10 which is set up in the destination IP address field (C), and video packet port information which is set up in the source port field (D), and transmits it to the first IP terminal 10 (S310).

The first IP terminal 10 recognizes the private IP address information and video packet port information of the second IP terminal 20 included in the received video port request message, and then transmits to the second IP terminal 20 a video port response message (Video RTP Address response) in which the private IP address information and video packet port information of the second IP terminal 20 are set up as the destination IP address information and destination port information (S320).

At this point, the second router 40-2 recognizes the voice packet port information and video packet port information included in the voice port request message and video port request message received from the second IP terminal 20, and generates the NAT table 42a in which the private IP address information, the public IP address information and the port information of the second IP terminal 20 are stored.

Furthermore, the second router 40-2 converts the voice port request message and video port request message, received from the second IP terminal 20 from the private IP address information of the source IP address field (B), into the public IP address information, and from the voice packet port information and video packet port information to port information used in the public network 60, and then transmits them to the first IP terminal 10 connected to the first private network 51 through the first router 40-1.

The first router 40-1 converts the source IP address information of each port response message received from the first IP terminal 10 from the private IP address information into the public IP address information, and the source port information from the port information used in the first private network 51 into the port information used in the public network 60, and then transmits them to the second IP terminal 20 through the second router 40-2.

The second router 40-2 converts the source IP address information of each port response message from the public IP address information into the private IP address information of the second private network 52, and from the source port information into the port information used in the second private network 52, and then transmits the converted information to the second IP terminal 20.

When the second IP terminal 20 recognizes the public IP address information and the port information of the first IP terminal 10, it transmits a response message (Alerting) for a call request message received from the switching system 30 to the switching system 30 (S330), and the switching system 30 transmits the response message to the first IP terminal 10 (S340).

At this point, the response message transmitted by the second IP terminal 20 uses the public IP address information and signaling port message of the second IP terminal 20.

Furthermore, the switching system 30 sets up a voice call to the second IP terminal 20, and then to the first IP terminal 10, and sets up a voice call between the first IP terminal 10 and the second IP terminal 20 (S350 and S360).

The IP terminals 10 and 20 exchange the voice packet and video packet with each other, using the recognized voice packet port information and video packet port information of each terminal (S370 and S380).

That is, when the voice call is set up, each of the IP terminals 10 and 20 transmits the voice packet based on the voice signal using the public IP address information and voice packet port information of the other IP terminal, and directly transmits the video packet based on the video signal using the public IP address information and video packet port information of the other IP terminal without passing through the switching system 30.

As described above, in accordance with the present invention, IP terminals connected to one another through different private networks exchange packets without passing through a switching system for controlling a voice call, so that efficiency of resource usage in the switching system can be maximized.

Furthermore, it is possible to minimize packet transmission delay and to maximize the quality of voice or video information transmitted through the packets by directly exchanging packets between the IP terminals.

While the present invention has been described with reference to an exemplary embodiment thereof, it will be understood by those skilled in the art that various changes in form and detail may be made therein without departing from the spirit and scope of the present invention as defined by the following claims.

What is claimed is:

1. A system for providing a packet communication service, wherein at least one Internet protocol (IP) terminal is connected to a public network through a private network which is different from other private networks, the system comprising:
a switching server for transmitting a call request message while managing at least one of address information and port information of each said at least one IP terminal;
a second IP terminal for receiving the call request message from the switching server, and for setting up at least one of destination information as first address information and first port information of the first IP terminal included in the call request message as destination information, for transmitting to the first IP terminal a first message including at least one of second address information and second port information set up in advance, for setting up destination information of the packet as said at least one of the first address information and the first port information, and for transmitting a packet; and
a first IP terminal for transmitting the call request message to the switching server through said at least one of the first address information and the first port information, for setting up the destination information of the packet as the second address information included in at least one of a first message and second port information included in the first message, and for transmitting the destination information.

2. The system according to claim 1, further comprising at least one router for converting at least one of private address information and private port information included in a packet received from the private network into corresponding at least one of public address information and public port information, respectively, and for converting at least one of public address information and public port information included in a packet received from the public network into corresponding at least one of private address information and private port information, respectively.

3. The system according to claim 2, wherein each said at least one router comprises:
a storage for storing an address conversion table having said at least one of private address information and private port information used in the private network by each said at least one IP terminal, and for storing said at least one of public address information and public port information corresponding to said at least one private address information and private port information; and
an address conversion processor for searching the address conversion table for said at least one of address information and port information corresponding to said at least one of address information and port information, respectively, recognized in at least one of the test message and the packet received from each said at least one IP terminal, and then converting the searched said at least one of address information and port information, and for generating the address conversion table based on said at least one of address information and port information included in the first message.

4. The system according to claim 1, wherein the switching server comprises:
a database for storing at least one of telephone number information, address information and port information of each said at least one IP terminal; and
a terminal information manager for extracting said at least one of telephone number information, address information and port information included in the test message received from each said at least one IP terminal, for managing the information using the database, and for transmitting a call request message, including at least one of address information and port information of the first IP terminal searched from the database, to the second IP terminal when the call request message is received from the first IP terminal.

5. The system according to claim 4, wherein the terminal information manager transmits the call request message to the second IP terminal, and transmits an information request message, including said at least one of port information and public address information of the first IP terminal, to the second IP terminal, so as to transmit said at least one of address information and port information of the second IP terminal to the first IP terminal.

6. The system according to claim 1, wherein each said at least one IP terminal comprises:
a memory for storing address information assigned from one of network and port information to exchange the packet; and
a message processor for generating a test message using said at least one of address information and port information stored in the memory, and for transmitting, to the first IP terminal when connected to the network, the first message in which said at least one of address information and port information of the first IP terminal recognized from the call request message received from the switching server is set up as destination information.

7. The system according to claim 6, wherein the message processor transmits, to the second IP terminal, a second message in which source information recognized in response to the first message received from the second IP terminal is set up as destination information.

8. The system according to claim 6, wherein the message processor transmits the packet by means of said at least one of address information and port information of the first IP terminal recognized in the second message received from the first IP terminal as a response message responsive to the first message.

9. The system according to claim 6, wherein the message processor generates the first message when receiving, from the switching server, an information request message including at least one of signaling port information and public address information of the first IP terminal.

10. The system according to claim 6, further comprising:
a user interface for providing at least one of a telephone number signal and a voice signal based on a selection by a user, and for outputting voice information based on a received voice signal;
a video processor for providing a video signal based on video information to be photographed, and for displaying video information based on the received video signal when a voice call is set up; and
a controller for setting up the destination information of the packet based on at least one of the voice signal and the video signal as said at least one of address information and port information of a recognized opposite IP terminal, and then transmitting the set up destination information to the opposite IP terminal, and for transmitting said at least one of the voice signal and video signal included in the packet received from the opposite IP terminal to at least one of the user interface and the video processor.

11. The system according to claim 1, wherein the address information comprises at least one of private IP address information used in each private network and public IP address information used in the public network.

12. The system according to claim 1, wherein the port information comprises at least one of signaling port information for exchanging a signaling packet to set up a voice call, voice packet port information for exchanging a voice packet of voice information, and video packet port information for exchanging a video packet of video information.

13. An Internet protocol (IP) terminal connected to a network through a private network, comprising:
a memory for storing public address information assigned from the network, information on at least one public port exchanging packets, and at least one of public address information and information on at least one public port of another IP terminal recognized through a message received from said another IP terminal;
a message generator for generating a plurality of test messages based on said at least one public address information and the port information stored in the memory, a call request message based on a selection by a user, and a response message for storing at least one of public address information and port information recognized from an information transmission message received from said another IP terminal in the memory, and for setting up at least one of recognized public address information and port information of said another IP terminal as destination information when connected to the network; and
a packet processor for transmitting each message generated in the message generator to the network, for setting up the destination information of a voice packet generated based on at least one of a voice signal and a video packet generated based on a video signal as said at least one of recognized public address information and port information of said another IP terminal, and for transmitting the set information by means of the port information stored in the memory.

14. A method of providing a service in a packet communication service provision system which includes at least one Internet protocol (IP) terminal connected to a public network through a private network, private networks being different from one another, and through a switching server, said method comprising the steps of:
managing, at the switching server, at least one of address information and port information of each said at least one of IP terminal using an information table;
when a call request message is received from a first IP terminal, transmitting the call request message from the switching server to a second IP terminal, the call request message including said at least one of address information and port information of the first IP terminal obtained from the information table;
setting up, at the second IP terminal, said at least one of address information and port information of the first IP terminal which is recognized from the call request message as destination information, and transmitting a first message in which said at least one of address information and port information set up in advance is set up as source information for the first IP terminal; and
transmitting, at the first IP terminal, packets using said at least one of address information and port information of the second IP terminal recognized in the first message, and allowing the second IP terminal to transmit packets using said at least one of recognized address information and port information of the first IP terminal.

15. The method according to claim 14, wherein the address information comprises at least one of private IP address information used in each private network and public IP address information used in the public network.

16. The method according claim 14, wherein the port information comprises at least one of signaling port information for exchanging a signaling packet to set up a voice call, voice packet port information for exchanging a voice packet of voice information, and video packet port information for exchanging a video packet of video information.

17. The method according to claim 14, further comprising the steps of:
transmitting, from each IP terminal to the switching server, a test message including at least one of assigned address information and port information; and
generating, at the switching server, an information table based on said at least one of address information and port information of said each IP terminal included in the test message.

18. The method according to claim 14, further comprising the steps of:
transmitting, at the switching server, an information request message including signaling port information in which at least one of the address information and a signaling packet of the first IP terminal is exchanged with the second IP terminal; and
generating, at the second IP terminal, the first message in which said at least one of address information and signaling port information included in the information request message is set up as destination information.

19. The method according to claim 14, further comprising the steps of:
when said at least one of address information and port information set up in at least one of each message and packet comprise at least one of private address information and private port information, converting said at least one of address information and port information into corresponding said at least one of public address information and public port information, respectively, and transmitting the converted information to the network; and
when said at least one of address information and port information set up in said at least one of each message and packet comprises said at least one of public address information and the public port information, converting said at least one of address information and the port information into corresponding said at least one of private address information and private port information, respectively, and transmitting the converted information to at least one of the IP terminal and the switching server through a corresponding private network.

20. The method according to claim 14, further comprising the steps of:
transmitting, from the first IP terminal to the second IP terminal, a second message in which at least one of address information of the second IP terminal and port information of the second IP terminal, which is recognized in the received first message, is set up as destination information;
allowing source information of a response message to be converted from at least one of the private address information of the first IP terminal and the private port information of the first IP terminal to at least one of public address information and public port information; and
recognizing, at the second IP terminal, at least one of the public address information of the first IP terminal and the public port information of the first IP terminal included in the second IP message.
